(19) United States
(12) Patent Application Publication
(10) Pub. No.: US 2003/0032514 A1
(43) Pub. Date: Feb. 13, 2003

(54) Power transmission belt

(76) Inventors: Charles O. Edwards, Arvada, CO (US); Lance D. Miller, Highlands Ranch, CO (US); Bobbie E. South, Littleton, CO (US); Douglas R. Sedlacek, Englewood, CO (US)

Correspondence Address: Jeffrey Thurnau, The Gates Corporation, 900 S. Broadway, MS: 31-4-1-A3, Denver, CO, 80209, US

(21) Appl. No.: 09/918,632

(22) Filed: Jul. 30, 2001

(51) Int. Cl. F16G 1/00; F16G 9/00; F16G 5/00

(52) U.S. Cl. 474/263; 474/237; 474/260

(57) ABSTRACT

The invention comprises a multi-ribbed belt having a modified coefficient of friction at a belt side/pulley interface. The modified coefficient of friction causes the belt to operate more quietly. The modified coefficient of friction is the result of graphite and carbon black added to the elastomer. Graphite is added in the amount of approximately 40 to 100 parts by weight of graphite for each 100 parts by weight of polymer. Carbon black is added in the amount of approximately 20 to 100 parts for each 100 parts elastomer.

### FIELD OF THE INVENTION

The invention relates to power transmission belts, more particularly to multi-ribbed power transmission belts having dry lubricant for a modified coefficient of friction for quieter operation.

### BACKGROUND OF THE INVENTION

Power transmission belts are used to transmit power from a driver pulley or sprocket to a driven pulley or sprocket. The nature of the interface between the belt and the pulley groove determines in large part how the system will operate.

The pulley to belt coefficient of friction determines in part how much noise will be generated by the system. Aramid fibers are used for noise reduction, but they are relatively costly. Various other additives have been used in the belt to modify the belt rubber friction so that noise generation is reduced. Such additives include PTFE in particulate form. Other additives that bloom on the surface of the belt have been used. Certain oils have also been added to the elastomer in order to effect a change in the coefficient of friction. However, the oils tend to migrate from the product during the life of the product, reducing their effectiveness. Molybdenum disulfide has also been used but with a minor reduction in noise.

Representative of the art is U.S. Pat. No. 4,031,768 (1977) to Henderson et al. which discloses a raw-edged v-belt being made of an elastomer compound having anti-friction properties. The belt comprises a v-belt.

Also representative of the art is U.S. Pat. No. 4,244,234 (1981) to Standley which discloses a v-belt having reduced coefficient of friction with a friction reducing layer bonded to a body. The layer comprises an elastomer, activated carbon and at least one friction-reducing material.

What is needed is a multi-ribbed belt having a modified coefficient of friction at a belt pulley interface. What is needed is a multi-ribbed belt having a dry lubricant dispersed throughout a belt body. What is needed is a multi-ribbed belt having graphite to modify a coefficient of friction at a belt pulley interface. What is needed is a multi-ribbed belt having significantly reduced noise generation. The present invention meets these needs.

### SUMMARY OF THE INVENTION

It is a feature of the invention to provide a multi-ribbed belt having a modified coefficient of friction at a belt pulley interface.

Another feature of the invention is to provide a multi-ribbed belt having a dry lubricant dispersed through a belt body.

Another feature of the invention to provide a multi-ribbed belt having graphite to modify a coefficient of friction at a belt pulley interface.

Another feature of the invention to provide a multi-ribbed belt having significantly reduced noise generation.

Other aspects of the invention will be pointed out or made obvious by the following description of the invention and the accompanying drawing.

The invention comprises a multi-ribbed belt having a modified coefficient of friction at a belt side/pulley interface. The modified coefficient of friction causes the belt to operate more quietly. The reduced coefficient of friction is the result of graphite and carbon black added to the elastomer. Graphite is added in the amount of approximately 40 to 100 parts by weight of graphite for each 100 parts by weight of polymer. Carbon black is added in the amount of approximately 20 to 100 parts for each 100 parts elastomer.

### BRIEF DESCRIPTION OF THE DRAWINGS

The accompanying drawings that are incorporated in and form a part of the specification illustrate preferred embodiments of the present invention, and together with a description, serve to explain the principles of the invention.

FIG. 1 is a perspective cross-sectional view of the inventive belt.

FIG. 2 is a perspective cross-sectional view of an alternate embodiment.

### DETAILED DESCRIPTION OF THE PREFERRED EMBODIMENT

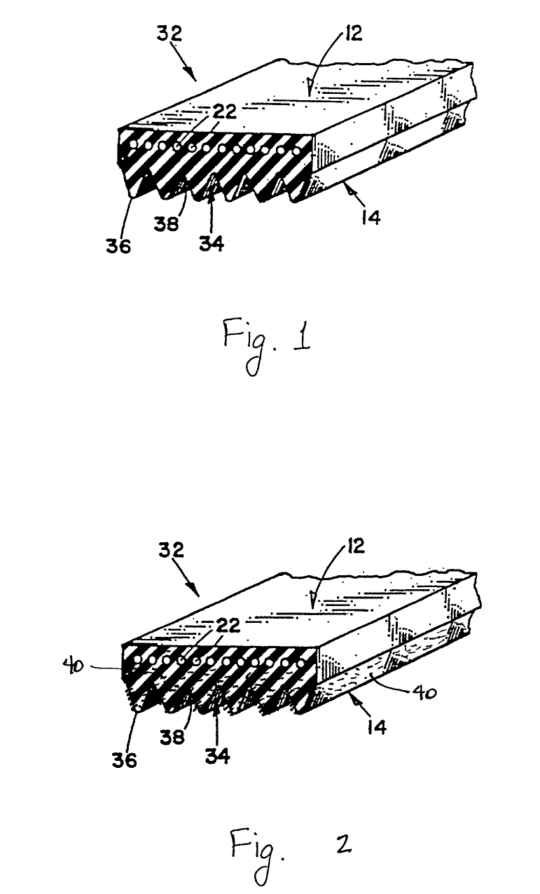

FIG. 1 is a perspective cross-sectional view of the inventive belt. Belt 32 comprises the main elastomer body portion 12 and tensile members 22. Tensile members 22 comprise a helically wound cord and are disposed within body portion 12. The pulley contact portion 14 comprises a multi-ribbed profile having longitudinally aligned ribs 34 which comprise a plurality of ribs 36 alternating with rib apexes 38.

The inventive belt significantly reduces belt noise. Belt noise can be created by a number of mechanisms. In multi-ribbed belts noise can be created by a pulley-belt interface misalignment. Proper alignment can reduce or eliminate this form of noise. If proper alignment is not maintained, excessive radial sliding results and noise is created.

Another source of noise is improper belt tension. If the belt tension is too low, the belt tends to have an excessive tangential sliding movement within the pulley. This friction source creates noise. The inventive belt significantly reduces noise caused by a low belt tension.

One technique for reducing noise in belts is to incorporate certain types of short length textile fibers into the belt elastomer that act at the belt/pulley interface. Increasing the fiber loading in the elastomer can reduce noise caused by misalignment. However, incorporation of fibers into the elastomer has little effect on the noise caused by friction from the tangential sliding movement of the belt within the pulley due to improper tension.

Reduction of noise caused by improper tension is of great importance since the tension of a belt will generally change during its operating life. The tension change may be a result of a number of factors, including belt stretch, belt surface wear and shaft bearing wear; each tending to reduce belt tension-leading to tangential slip noise. The inventive belt significantly reduces noise caused by relatively low belt tension while simultaneously providing the necessary torque transmitting capacity.

The inventive belt 32 comprises any suitable elastomer material preferably in the form of a polymer as part of the elastomer matrix. The preferred elastomer polymer comprises EPDM. The belt body may also comprise polychloroprene, polysisoprene, styrene-butadiene rubbers, polybutadiene, and the like, and blends thereof. The belt body elastomer may also comprise neoprene rubber.

The inventive belt employs graphite mixed in the elastomer matrix to provide coefficient of friction modifying properties at a belt rib surface. Chemically, graphite is a lubricous carbonaceous material made up of carbon atoms that are arranged in polynuclear aromatic, hexagonal ring arrays. Hexagonal arrays are oriented parallel to the “a” crystallographic axes. These arrays form sheets called graphene layers. Graphene layers are stacked parallel to the “c” crystallographic axis. Graphene layers stacked perpendicular to the “c” crystallographic axis have high inter-layer strength as a result of strong, covalent, carbon-carbon sigma bonds. However, the weak pi-bonding, which holds adjacent graphene layers in alignment yield with minimal energy allowing graphene layers to peel away from each other. Groups of graphene layers cleaved away from a graphite crystal will provide a tough, highly lubricious film that can effectively fill and “cap” disparities between rubbing surfaces.

The amount of graphite added to the elastomer is in the range of approximately 40-100 parts by weight of graphite for each 100 parts by weight of polymer. The graphite particle size in the inventive belt ranges from approximately 5 μm (micron) to 100 μm (micron).

In the preferred embodiment the belt comprises approximately 50 parts by weight of graphite for each 100 parts by weight of polymer, with a graphite particle size of approximately 15 μm. The amount of graphite contained within the belt body may be varied within the range to create the desired coefficient of friction, and thereby the desired noise reduction effect.

The inventive belt also comprises carbon black included in the elastomer with the graphite. The carbon black can be any known in the art of reinforcing elastomer compositions. Examples include SAF, HAF and GPF, furnace process gas blacks such as HMF, SRF and the like. The carbon black acts as reinforcing filler contributing to compound properties such as tensile strength, wear resistance, hardness and modulus.

The amount of carbon black added to the elastomer is in the range of approximately 20 to 100 parts by weight of carbon black for each 100 parts by weight of polymer. The preferred embodiment comprises approximately 35 parts by weight of carbon black. The carbon black particle size is in the range of approximately 0.1 μm to 0.01 μm. This corresponds to an ASTM classification range of N100 to N700. N220 is used in the preferred embodiment. Other suitable reinforcing fillers include silica, clay, and calcium carbonate, each in like sizes and amounts as described for the carbon black.

Although graphite and carbon black are both forms of carbon, each has different physical properties. It is the combination of the graphite and carbon black, each with the properties described herein, that gives the inventive belt the desired characteristics of a modified coefficient of friction for reducing noise while maintaining the required torque transmitting capability, modulus and wear.

TABLE 1

| | PHR |
|---|---|
| EPDM | 100 |
| GRAPHITE | 50 |
| CARBON BLACK | 35 |
| ZINC DIMETHACRYLATE | 15 |
| ZINC OXIDE | 3 |
| STEARIC ACID | 1 |
| ANTIOXIDANT | 1 |
| PROCESSING OIL | 6 |
| PEROXIDE (ACTIVE CONTENT) | 2 |

Table 1 presents a typical elastomer compound for the inventive belt.

The addition of graphite determines an effective coefficient of friction (ECOF) in the inventive belt. ECOF is illustrated as follows. When a block is placed on an inclined plane and the plane is inclined until steady sliding of the block occurs, the tangent of the angle of the inclined plane is defined as the coefficient of friction. In this case, the block is assumed to lie flat on the inclined plane such that there are no other forces on the block other than those arising from the operation of gravity on its mass and from friction (i.e. no wedging) In this respect, the inclined plane example is like a flat belt running on a flat sheave. A test of the torque capacity of this system would be a measure of the “true” coefficient of friction (COF without wedging). However, V belt and multi-ribbed belts have a shape that causes wedging to occur. The V profile of each belt and sheave cause an increase in normal force on the belt during seating in the pulley. This additional force results in an increase in torque capacity not due to an increase in belt true COF but due to the combination of wedging and belt true COF.

Mathematically speaking, the two equations below illustrate the difference. See Belt Selection and Application for Engineers; Erickson, Wallace D., ed. Dekker, New York, 1987, pp. 33-35.

$$\frac{{T}_{t}}{{T}_{s}} = {e}^{μθ}$$

Where:

Tt=tight side tension [N]

Tₛ=slack side tension [N]

μ=coefficient of friction (true) [1]

θ=wrap angle [rad]

V-Belt:

$$\frac{{T}_{t}}{{T}_{s}} = {e}^{k μθ}$$

Where: k=wedging factor [1]

Most V belt and multi-ribbed belt tests that measure belt friction are not measuring μ, but are actually measuring kμ, or put another way, the effective coefficient of friction, ECOF. In other words, belt testers provide a COF value where wedging has not been factored out. This product of wedging and true coefficient of friction, kμ, has been defined as effective COF. The true COF measurement has been defined as the COF of the belt in the absence of wedging.

The compound formula in Table 1 gives an effective coefficient of friction at the belt pulley interface in the inventive belt of approximately 1.10. The amount of graphite may be adjusted to cause the ECOF to be in the range of approximately 0.90 to 1.60 with attendant noise control. The effective coefficient of friction of other multi-ribbed belts, Belt A and B in Table 2 each of like construction as shown in Table 1 but not containing graphite, is in the range of approximately 1.61 to 1.80. Selective reduction of the ECOF in this manner reduces tangential noise. This is very desirable since tangential slip can cause annoying “chirping” caused by belt acceleration during load changes on automotive applications.

One can appreciate that it is necessary to balance the ECOF reduction while maintaining a sufficient ECOF to transmit a torque to a driven pulley. An excessively low ECOF, for example less than 0.60, will render the belt useless for its intended purpose of transmitting sufficient torque, particularly in wet applications. An excessively high ECOF, for example greater than 2.00, will defeat the purpose of noise reduction at the belt/pulley interface.

The inventive belt was tested for tangential slip noise generation. Tangential slip noise is noise generally caused by reduced belt tension. The tests indicate that the inventive belt operates considerably quieter than comparable multi-ribbed belts not having graphite as a frictional modifier.

[image]

Table 2 depicts the results of the tangential slip noise test. The tangential slip test comprises running a belt over three pulleys, with one pulley having 40° of wrap. The belt is tested under 90N of tension at a speed of 600 RPM. The inventive belt generates a sound pressure level of approximately 88 dB while the non-graphite belts generated between 120 dB (Belt B) and 125 dB (Belt A); clearly a significant noise improvement.

In an alternate embodiment, fibers can be added to the elastomer compound in Table 1 to modify the ECOF. FIG. 2 is a perspective cross-sectional view of an alternate embodiment. In particular, aramid or cotton fibers 40 may be added to the elastomer at the mixing stage. The aramid fibers can be approximately 3 mm in length and are chopped. The aramid fibers are added in the amount of approximately 0.5 parts per hundred up to approximately 3.0 parts per hundred. The fibers in conjunction with the graphite and carbon black modify the ECOF sufficiently to eliminate or significantly reduce tangential slip noise.

The alternate embodiment having fibers is fabricated by plying an undercord having a fiber loading, as described above, and an overcord on a mandrel with a tensile cord wound between the plies. The belts are cured on the same mandrel on which they are plied. The cured slab is cooled and stripped from the mandrel. The slab is slit into individual belt cores. These cores then have the multi-rib profile cut or ground into the undercord stock. The cutting or grinding process exposes ends of the fibers on a belt rib/pulley engaging surface.

Manufacture.

The composition in Table 1 can be mixed conventionally in an internal mixer, e.g., a Banbury mixer, with all of the ingredients added as desired. The elastomer composition is calendered to provide a sheet-like stock having a thickness in the range of approximately 0.010″ to 0.070″.

The inventive belt is constructed in a process of sequential application of elastomer stock on a build drum having an expanding membrane. The belt is vulcanized by using the expanding membrane to press the belt slab into a ribbed outer shell while curing the raw belt slab. The outer shell mold impresses the multi-ribbed profile into the belt undercord.

In particular, a first elastomer layer is plied on the mandrel. Next, another elastomer layer is applied over the first layer. Once completely fabricated the elastomer layers applied first that ultimately overlie the tensile cord are referred to as the overcord. Next, the tensile members or cords 22 are wound over the preceding elastomer layers. Next, another elastomer layer is applied over the tensile cords. Once the belt is fabricated the layers applied last that ultimately underlie the tensile cords are referred to as the undercord. The undercord also comprises the particular belt profile, in the preferred embodiment, multi-ribbed.

Although a single form of the invention has been described herein, it will be obvious to those skilled in the art that variations may be made in the construction and relation of parts without departing from the spirit and scope of the invention described herein.

I claim:

1. A belt comprising:
a body made of an elastomer compound comprising a polymer and graphite;
the graphite in an amount of approximately 40 to 100 parts by weight for each 100 parts by weight of the polymer;
a tensile member disposed within the body; and
the body having a multi-ribbed profile.

2. The belt as in claim 1 further comprising carbon black.

3. The belt as in claim 2, wherein the carbon black comprises approximately 20 to 100 parts by weight for each 100 parts by weight of polymer.

4. The belt as in claim 3, wherein the graphite comprises approximately 50 parts by weight for each 100 parts by weight of polymer.

5. The belt as in claim 4, wherein the carbon black comprises approximately 35 parts by weight for each 100 parts by weight of polymer.

6. The belt as in claim 5, wherein the tensile member comprises a helically wound load-carrying cord.

7. The belt as in claim 5, wherein the elastomer comprises EPDM.

8. The belt as in claim 5, wherein a coefficient of friction at a belt pulley interface is in the range of approximately 0.60 to 2.0.

9. The belt as in claim 5 further comprising fibers at a pulley engaging surface.

10. The belt as in claim 9, wherein the fibers comprise aramid.

11. A belt comprising:
a body made of an elastomer compound comprising a polymer and graphite whereby a rib coefficient of friction is modified thereby reducing an operating noise;
a tensile member disposed within the body; and
the body having a multi-ribbed profile.

12. The belt as in claim 11 further comprising:
carbon black, wherein the carbon black comprises approximately 20 to 100 parts by weight for each 100 parts by weight of polymer.

13. The belt as in claim 11, wherein the graphite comprises approximately 40 to 100 parts by weight for each 100 parts by weight of polymer.

14. The belt as in claim 11, wherein the graphite comprises approximately 50 parts by weight for each 100 parts by weight of polymer.

15. The belt as in claim 14, wherein the carbon black comprises approximately 35 parts by weight for each 100 parts by weight of polymer.

16. A belt comprising:
a body made of an elastomer compound comprising a polymer and graphite;
the graphite is in the amount of approximately 40 to 100 parts by weight for each 100 parts by weight of the polymer;
a tensile member disposed within the body; and
the body having a multi-ribbed profile.

17. A belt as in claim 16 further comprising a reinforcing filler.

18. The belt as in claim 17, wherein the reinforcing filler is in the amount of approximately 20 to 100 parts by weight for each 100 parts by weight of polymer.

19. The belt as in claim 17, wherein the reinforcing filler comprises carbon black.

20. A belt comprising:
a body comprising an elastomer compound and comprising a polymer and a lubricious carbonaceous material for modifying a coefficient of friction;
the lubricious carbonaceous material in the amount of approximately 40 to 100 parts by weight for each 100 parts by weight of the polymer;
the body comprising a reinforcing filler;
a tensile member disposed within the body; and
the body comprising a multi-ribbed profile.

21. The belt as in claim 20 wherein the lubricious carbonaceous material comprises graphite.

22. The belt as in claim 21, wherein the reinforcing filler comprises carbon black in the amount of approximately 20 to 100 parts by weight for each 100 parts by weight of the polymer.

23. The belt as in claim 22 further comprising fibers.

24. The belt as in claim 23, wherein the fibers comprise one of aramid or cotton.

25. A belt comprising:
a body comprising an elastomer compound, the elastomer compound comprising a polymer and a lubricious material and a reinforcing filler;
the lubricious material comprising aromatic ring arrays in the amount of approximately 40 to 100 parts by weight for each 100 parts by weight of the polymer;
the reinforcing filler in the amount of approximately 20 to 100 parts by weight for each 100 parts by weight of polymer;
a tensile member disposed within the body in a longitudinal direction; and
the body comprising a multi-ribbed profile.

26. The belt as in claim 25, wherein the lubricious material further comprises arrays oriented parallel to a crystallographic axis.

27. The belt as in claim 26, wherein the lubricious material comprises a carbonaceous material.

28. The belt as in claim 25, wherein a lubricous material size is in the range of approximately 5 microns to 100 microns.

29. The belt as in claim 28, wherein a reinforcing filler size is in the range of approximately 0.1 micron to 0.01 micron.

30. The belt as in claim 29 wherein the lubricious material comprises graphite, whereby a body rib coefficient of friction is modified.

31. The belt as in claim 30, wherein the reinforcing material comprises one of carbon black, silica, clay or calcium carbonate.

32. The belt as in claim 4, wherein a graphite size is in the range of approximately 5 microns to 100 microns.

33. The belt as in claim 5, wherein a carbon black size is in the range of approximately 0.1 micron to 0.01 micron.
